(19) United States
(12) Patent Application Publication
(10) Pub. No.: US 2014/0087684 A1
(43) Pub. Date: Mar. 27, 2014

(54) Online System and Method for a Secure Identification Database

(71) Applicants: Luis Rodriguez, Phoenix, AZ (US); Lidieth Libby, Scottsdale, AZ (US); Gregory Libby, Scottsdale, AZ (US)

(72) Inventors: Luis Rodriguez, Phoenix, AZ (US); Lidieth Libby, Scottsdale, AZ (US); Gregory Libby, Scottsdale, AZ (US)

(21) Appl. No.: 14/032,038

(22) Filed: Sep. 19, 2013

Related U.S. Application Data
(60) Provisional application No. 61/703,201, filed on Sep. 19, 2012.

(51) Int. Cl. H04W 4/22

(52) U.S. Cl. CPC H04W 4/22
USPC 455/404.1

(57) ABSTRACT

A method and system are provided for storing and communicating a personal notification and information in the event of an emergency. An individual a personal identification item (such as a bracelet or an identification card) is kept on the individual's person and includes information for sending an emergency alert to a host computer system via a mobile user computer device. The individual is prompted to provide personal information for storage by the host computer system, which includes medical information associated with the individual and emergency contact information for one or more contact persons. The host computer system receives an emergency alert from the user computer device, and in response uses the emergency contact information to automatically communicate information relating to the emergency alert to the one or more contact persons such as by emails and texts messages. The emergency alert can be a missing person alert or an accident alert.

### RELATED APPLICATION

This application claims the benefit of U.S. Provisional Application No. 61/703,201, filed Sep. 19, 2012, entitled “Online System and Method for a Secure identification Database,” which is incorporated herein by reference.

### COPYRIGHT NOTIFICATION

Portions of this patent application include materials that are subject to copyright protection. The copyright owner has no objection to the facsimile reproduction by anyone of the patent document itself, or of the patent application as it appears in the files of the United States Patent and Trademark Office, but otherwise reserves all copyright rights whatsoever in such included copyrighted materials.

### BACKGROUND

This invention relates generally to emergency notification methods and systems. More specifically, it relates to a system and method that includes a secured identification database and that automatically and quickly alerts family and friends when a loved one is missing or injured.

After someone goes missing or is seriously injured, information currently is gathered by loved ones and for by “Amber Alert” This process, however, takes an average of 48 hours. There is a need for a system that can store and immediately provide current information in the event of such an emergency. It is an object of the present invention to provide such a system and method.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY

To achieve the foregoing objects, and in accordance with the purposes of the invention as embodied and broadly described in this document, there is provided a method and system for storing and communicating a personal notification and information in the event of an emergency. The method includes providing to an individual a personal identification item (such as a bracelet or an identification card) to be kept on the individual's person, wherein the personal identification item includes information for sending an emergency alert to a host computer system via a user computer device, such as a mobile computer device, laptop computer, a desktop computer, a smart phone, a tablet computer, or the like. The personal identification item also can include other key medical and identification data. The individual is prompted to provide personal information for storage by the host computer system. The personal information includes medical information associated with the individual and emergency contact information for one or more contact persons (which can include, for example, family and friends). The stored personal information is password-protected and can assist in locating a person that may be missing or in providing the best medical care to a person if injured, while warehousing contact information of all the people an individual may need for help in case of an emergency. The host computer system is used to receive an emergency alert from the user computer device. In response to the emergency alert, the host computer system uses the emergency contact information to automatically communicate information relating to the emergency alert to the one or more contact persons such as by emails and texts messages.

In one advantageous embodiment, the host computer system includes a computer processor and a database operative with computer processor to store personal information. The personal information is associated with an individual and includes medical information and emergency contact information for one or more contact persons. The individual has a personal identification item that includes information for sending an emergency alert to the host computer system via a user computer device. The computer processor is operative to: prompt the individual to provide the personal information for storage by the host computer system; receive an emergency alert from the user computer device; and in response to the emergency alert, use the emergency contact information to automatically communicate information relating to the emergency alert to the one or more contact persons. The personal identification item can comprise jewelry that includes identification information for the individual or an identification card for the individual. The medical information can include allergy information and the personal information includes physician information. The emergency alert can be a missing person alert or an accident alert.

The system according to the invention can disseminate information about a missing person within seconds to dozens of people including Emergency Services, which will have immediate access to the missing or injured person's vital health information. It allows a member to reach personal networks, alerting them to a possible crisis, at the touch of a button. Members can access their profile via the Internet, using a computer device that has an Internet connection and a web browser, such as a mobile computer device, laptop computer, a desktop computer, a smart phone, a tablet computer, or the like. The system also provides local police and Emergency Medical Services with critical information to aid in locating a missing person or in assisting an injured person.

The system can act as a member's personal “panic button” that allows a user to instantly mobilize a member's online and offline networks to help in case of an emergency. Since the member's information is already in the system, in the event of an emergency the information can be disseminated out to everyone in the member's contact list plus anyone else using the service in their vicinity who chooses to receive alerts.

### BRIEF DESCRIPTION OF THE DRAWINGS AND APPENDICES

The accompanying drawings and appendices, which are incorporated in and constitute a part of the specification, illustrate the presently preferred embodiments of the invention and, together with the general description given above and the detailed description of the preferred methods and embodiments given below, serve to explain the principles of the invention.

FIG. 1 is a functional block diagram of a preferred computer system and a network for practicing the present invention, including a computer system for hosting a website and mobile computer devices.

FIG. 2 is a block diagram showing a preferred architecture for a shopping website section of a host website for purchasing a personal identification item according to the present invention.

FIG. 3 shows an exemplary Login page displayed on the screen of a mobile computer device for user login.

FIG. 4 shows an exemplary Emergency page displayed on the screen of the mobile computer device after a user logs into a mobile secure identification application, which displays a Call 911 button, a Missing Alert button and an Accident Alert button.

FIG. 5 shows an exemplary Missing Alert page displayed on the screen of the mobile computer device in response to a user clicking the Missing Alert button,

FIG. 6 shows an exemplary Accident Alert page displayed on the screen of the mobile computer device in response to a user clicking the Accident Alert button.

FIG. 7 shows an exemplary My Profiles page displayed on the screen of the mobile computer device for viewing and editing member profiles.

FIG. 8 shows an exemplary Descriptive Information page displayed on the screen of the mobile computer device for entering and viewing a member's descriptive information.

FIG. 9 shows an exemplary My Account page displayed on the screen of the mobile computer device for viewing a member's account information.

FIG. 10 shows an exemplary Name and Vital Information page displayed on the screen of the mobile computer device for viewing such information of a member.

FIG. 11 shows an exemplary Medical Information page displayed on the screen of the mobile computer device for entering and viewing medical information such as a member's medications and allergies.

FIG. 12 shows an exemplary Physicians page displayed on the screen of the mobile computer device for viewing a member's treating physicians.

FIG. 13 shows an exemplary Emergency Contacts page displayed on the screen of the mobile computer device for viewing a member's emergency contacts.

FIG. 14 shows an exemplary Additional Information page displayed on the screen of the mobile computer device, which a member can use to add and view additional information.

FIG. 15 shows an exemplary Account Options page displayed on the screen of the mobile computer device for viewing and managing a user's account information.

FIG. 16 shows one example of a missing person alert in accordance with the present invention.

FIG. 17 shows an example of an accident alert in accordance with the present invention.

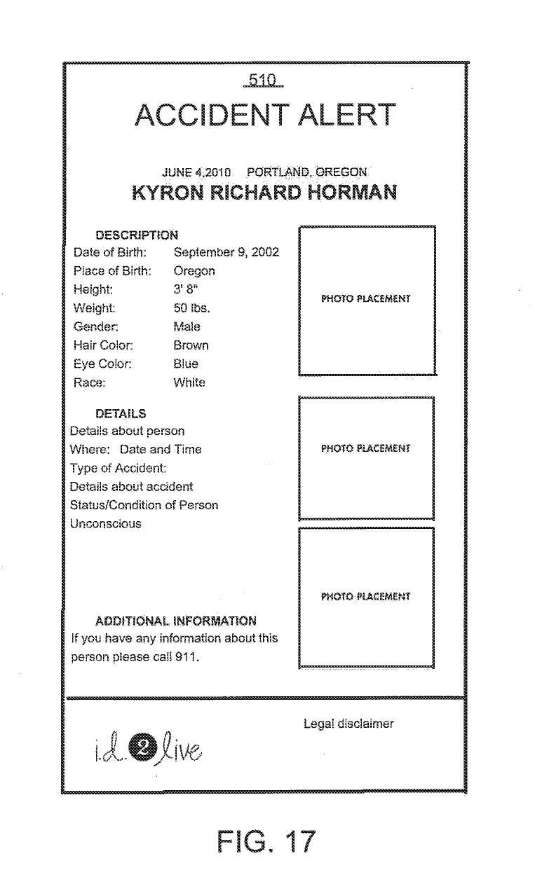

FIG. 18 shows an example of a notice of found person according to the present invention.

FIG. 19 shows a flow chart illustrating the steps of a method for providing emergency notifications according to the present invention.

### DESCRIPTION

According to the present invention, there is provided a secure identification system and method (sometimes referred to herein as the “ID2Live” system and method) that alerts family and friends when a loved one is missing or injured. The system and method also provides local police and Emergency Medical Services with critical information to find or aid the missing person. The system and method acts as a user's own personal “panic button” that allows the user to instantly mobilize his or her online and offline networks to help the user in case of emergency, such as a missing child.

### Overview

The system and method of the present invention allows a registered user (i.e., a member) to create, manage and activate a database of friends and family around the world; it allows the user to reach personal networks, alerting them to a possible crisis, at the touch of a button. The Web-based system is secure and customizable, allowing for quick dissemination of emails and texts messages (SMS). According to one aspect of the system and method, a customized identification product/jewelry, such as a bracelet or necklace, provides authorities with key medical and identification data on the members loved ones.

A password-protected database stores the information about a user's loved ones that can help find them or provide the best medical care, while warehousing contact information of all the people that the user may need for help in case of emergency. The servers that store the database are inside of a secure data center. After a user signs up as a member, the member can access their profile via Internet, using a computer, tablet, smart phone, etc. They can download a mobile application, for mobile devices, e.g., iPhone® and/or Android mobile devices.

The system and method according the present invention enables users to do the following:
Build a database of mission-critical information, by providing the tools to prepare for the greatest emergencies; the online service creates a secure database of mission-critical information—including pictures, fingerprints and short video for voice recognition that can be shared with authorities when a loved one is missing or injured.
Mobilize networks, by allowing anyone to immediately mobilize personal networks of friends and family, and by providing the tools to quickly alert authorities when someone is missing. No 24-hour waiting period, no runaway age restrictions, not one moment wasted.
Hold the power, by giving its members the power to determine when there is an emergency and immediately activate their networks.
Provide peace of mind for anyone who wants to protect their loved ones, ranging from children who wander off to elderly who become disoriented.

A user can think of the system and method of the present invention as his or her own personal, and possibly life-saving, “panic button.” A secure, online database captures mission-critical information about a user's loved ones that can help locate them or provide the best medical care. The database also acts as a warehouse of a user's personal contacts that will help him or her in case of emergency. The information is stored in a secure, password-protected data center and is accessed and shared when the user presses the “panic button” on their computer, tablet or smart phone (anything with a web browser).

The method and system of the invention is suited for everyone, ranging from children to the elderly to athletes to frequent travelers. That said, it is particularly useful in protecting young children who are most likely to go missing, and the elderly who are likely to become easily disoriented and lost. At the end of the day, the method and system provides peace of mind for anyone who wants to protect loved ones.

### Computer Network System

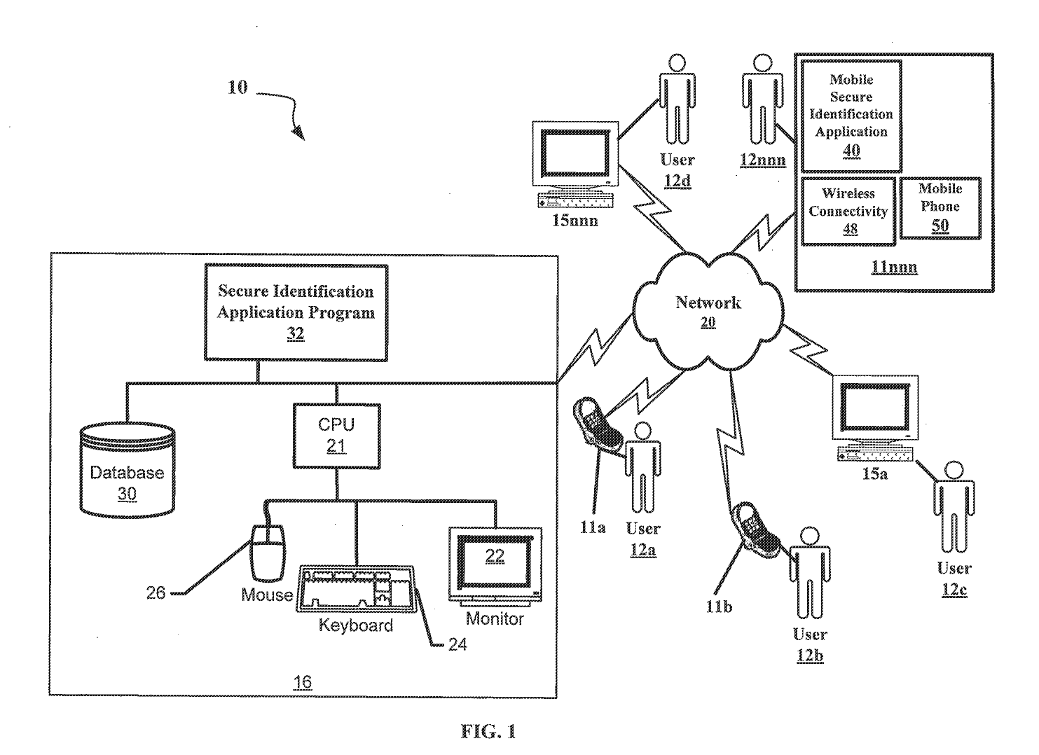

FIG. 1 illustrates a preferred computer network system 10 for practicing the present invention. The computer network system 10 includes a host computer system 16, which stores and processes the information described. Mobile users 12a-12nnn can access and communicate with the host computer system 16 via their respective mobile computer devices 11a, 11b and 11nnn or desktop/laptop computers 15a and 15nnn (where nnn refers to any number of users and user devices) coupled to the host computer system 16 via a computer network 20, such as the Internet, or by other suitable communications means. In a preferred embodiment of the invention, the computer network 20 comprises the Internet. Upon reading this specification, those skilled in the art will understand that, under appropriate circumstances, considering issues such as developments in computer hardware, software and connectivity, etc., other network configurations and devices also may suffice.

Still referring to FIG. 1, the host computer system 16 includes a central processing unit (CPU) 21 for processing data and program instructions and also includes input and output devices, as are well known in the art. For example, the host computer system 16 preferably includes a display screen or monitor 22, a keyboard 24, a mouse 26, a printer (not shown), etc. The host computer system 16 further includes data storage and memory devices, as are known in the art, for storing a database 30. The database 30 is used to store the data required by the system to provide the functionality described below. Preferably, the database 30 is a relational database, as is well known in the art. A secure identification application program 32 is operable with the database 30 and the mobile computer devices 11 or computers 15 to provide the functionality described below. Upon reading this specification, those skilled in the art will understand that, under appropriate circumstances, considering issues such as developments in computer hardware, software and connectivity, etc., various operating systems, programming languages and database management systems can be used.

Still referring to FIG. 1, preferably the mobile computer device 11 can store and run application programs, including a secure identification mobile application 40, which communicates with the host computer system 16 as described below. In a preferred embodiment, the mobile computer device 11 includes wireless connectivity 48 and a mobile telephone 50. The mobile computer device 11 can store and run the mobile secure identification application program 40, which includes functionality for communicating with the ID2Live website application program 32 and the database 30. Also, preferably the ID2Live website application program 32 includes a mobile version for use by mobile computer devices 11.

In a presently preferred embodiment, the secure identification website application program 32 is implemented in two separate websites: (i) a front-end shopping website; and (ii) an emergency information website for accessing a member's contact information. By accessing the shopping website, a customer can browse the products available online (e.g., personal identification jewelry), select the products that he or she would like to purchase and place an order using a credit card or other online payment method. The emergency information website provides processing features and maintenance of member information to be accessed in case of an emergency. Separation of these sites helps to ensure security of member data as that data is not accessible from the front end ecommerce site that is marketed to the public. Preferably, the servers are co-located inside a data center that meets appropriate standards of security and availability—such as the SAS 70 type II certification—and offers state-of-the-art connectivity, power, security, etc.

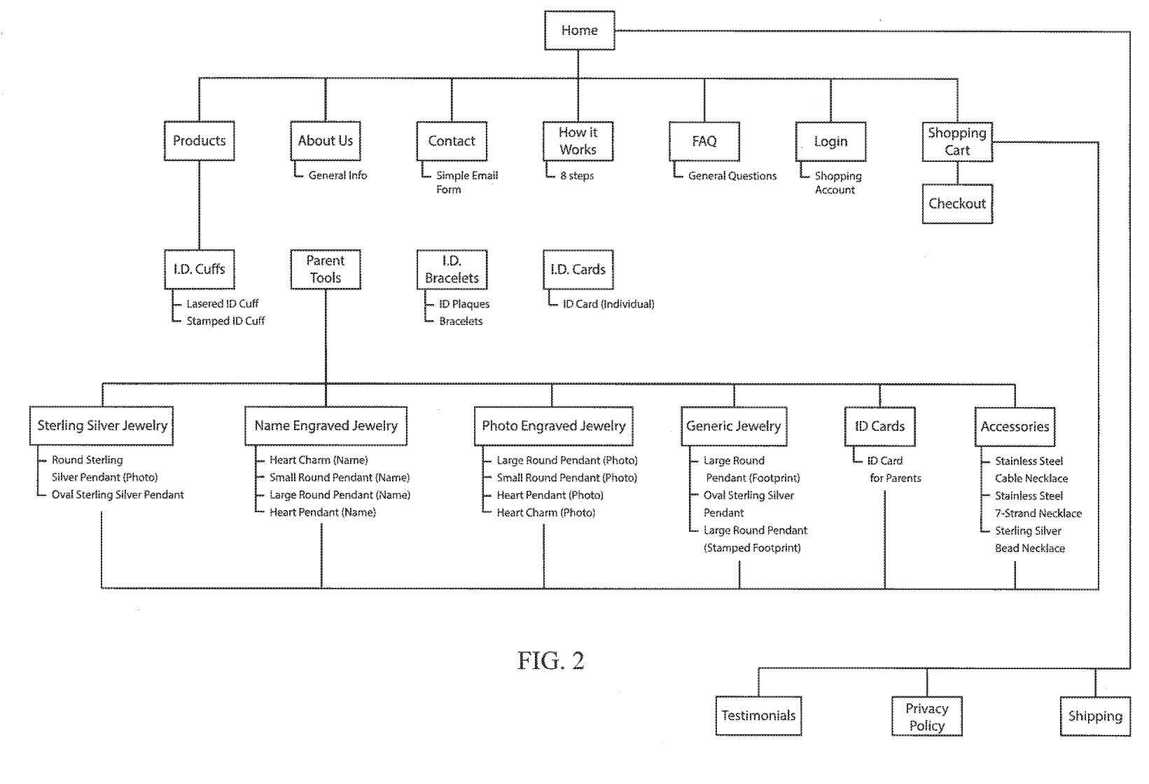

FIG. 2 illustrates a preferred architecture of an exemplary shopping front-end website according to the present invention. Appendix A includes website documentation that provides additional detail about one exemplary embodiment of the front-end shopping website and the emergency information website that comprise the website application program 32.

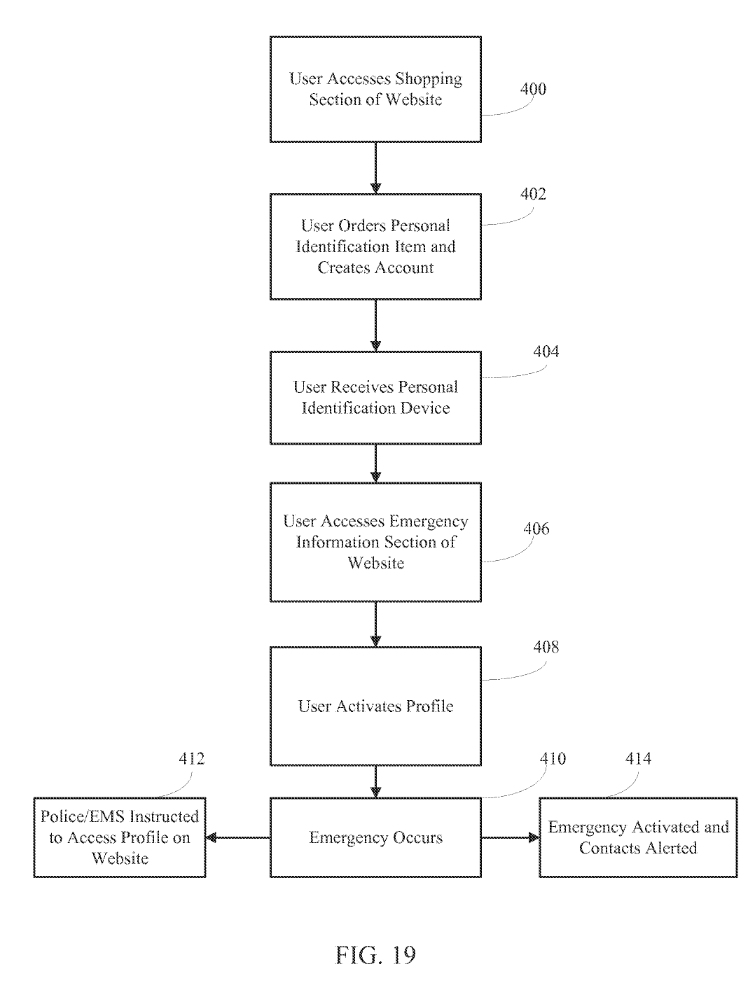

Referring to FIG. 19, the secure identification system 10 can be used to alert family and friends that their loved one is missing or injured. It also provides police and emergency medical services personnel with critical information. To use the system, a user begins by accessing the shopping website (step 400) and ordering a personal identification item (step 402), such as piece of jewelry that the he or she wears at all times or an ID card that the user keeps in his or her wallet. The personal identification item includes information for accessing a selected portion of the user's emergency information via the website 16. After the user receives the personal identification item (step 404), he or she can access the emergency information website (step 406) and register by completing a member profile (step 408). The user's member profile can include important medical information, emergency contacts, photographs, a short video, fingerprints and more. In the event of an emergency (step 410), the user's ID and PIN numbers can be provided to police or EMS personnel (including, e.g., from the identification jewelry or ID card) along with instructions for accessing the emergency information website (step 412). Police and EMS personnel can then have immediate access to the selected information in the registered user's online profile. Family and friends can also be alerted by activating a panic button on the registered user's smart phone or online (step 414). A “missing person flyer” or an “accident alert” can be created within seconds and sent by email or SMS to all the contacts that the registered member chooses.

### Website Access and Sign-up

In an exemplary embodiment, potential users can access the website 16 via their mobile computer devices 11 or desktop computers 15. As discussed above, in order to become a member, the customer accesses the website (step 400) which prompts her or him through the following sign-up process.
The customer must select a piece of identification jewelry, personalize it, buy it and create an account (with username and password) (step 402).
The customer has to fill/create a Profile with the requested information. The customer decides how much information they provide. In one preferred embodiment, the only information that is strictly required is the user's name and e-mail address.
Once the customer receives the piece of jewelry (step 404), he/she has to activate his/her profile or it will be activated automatically after 30 days of receipt (the jewelry package can include instructions for the activation process) (steps 406, 408).
To see a Profile or Activate the Panic Button, the member or the Emergency Responder has to go to the host website to enter the member's ID# and PIN# (included on the id2live products) and then choose to see the Profile or Activate the Panic Button (steps 410, 412). The ID# and PIN# give access to view a limited profile (just what the member wants to share) and/or Activate the PANIC BUTTON (Missing Alert and Accident Alert). The member has a Username and Password that provides full access to the whole account information, edit profiles related to such account, etc.
   Preferably the emergency information website includes a mobile version so it can also be accessed using a Smartphone, Tablet, etc. Also a native mobile secure identification application 40 can be provided for iPhone and Android.

Setting up an online profile in the system is a process that compiles all the information a member wants to share with their personal network in case of an emergency. According to a presently preferred process, the customer goes through the following steps:
1. SELECT: The customer selects his or her form of physical identification, either a printed ID card or a piece of jewelry that is customized for the customer. It will be created and shipped to the customer.
2. VISIT: The customer visits the ID2Live website 16 and creates their member profile, which includes medical information and personal information that could help the customer's network and authorities locate a missing person—including pictures, fingerprints and a short video used for voice recognition—that can be shared with authorities when a loved one is missing. The customer decides what information they want—or don't want—to share.
3. CREATE: The customer/member creates the database of their personal networks, including friends, work colleagues and family. The database includes email addresses and cell phone numbers. This is the list of people who will be automatically contacted if someone goes missing, which is much quicker than making multiple phone calls and emails.
4. ACTIVATE: When the customer/member pushes the “panic button,” their network receives the information via text or email, which can be easily shared via social media, printed flyers or word-of-mouth.

### Mobile User Interface

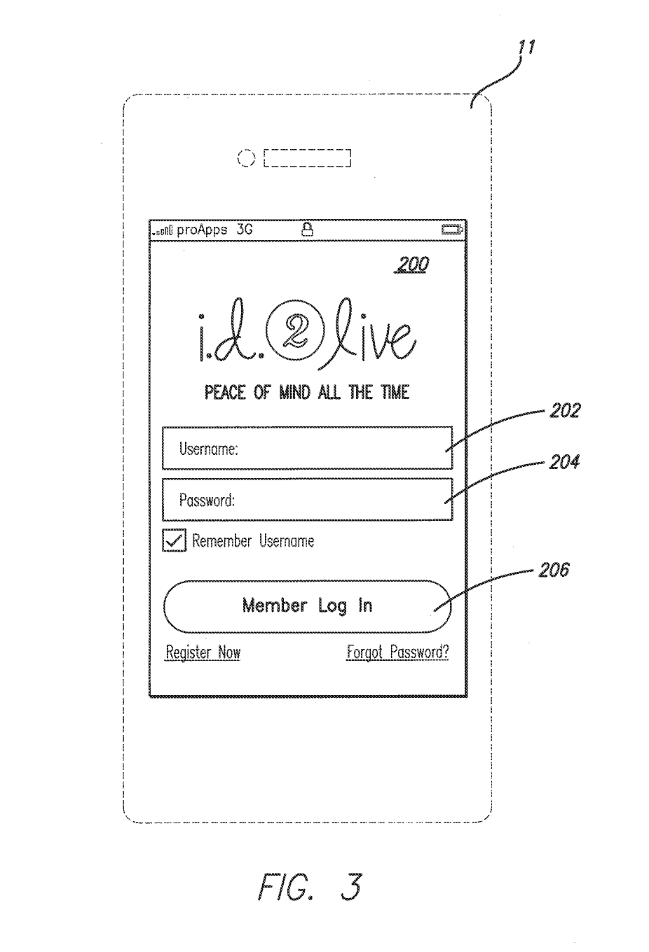

Referring to FIGS. 3-15, the functionality and operation of the system 10 will now be illustrated in connection with a more detailed description of the user interface of the mobile computer device 11. It will be understood that a user also can access the system 10 via a desktop or laptop computer browser that provides a similar user interface.

A user of a mobile computer device can launch the mobile secure identification application 40 by selecting a mobile secure identification application icon (not shown) displayed on the screen of the mobile computer device 11. In response, the mobile computer device 11 displays a Login page 200, such as that shown in FIG. 3. From the this page, the user 12 can login to the secure identification application program 32 of the host computer system 16 by entering a valid username in a displayed username field 202, entering a valid password in a displayed password field 204, and selecting a Member Log In button 206. In accordance with one preferred aspect of the invention, a user must have a membership account in order to log in to the host computer system 16.

### Emergency Alert Flow

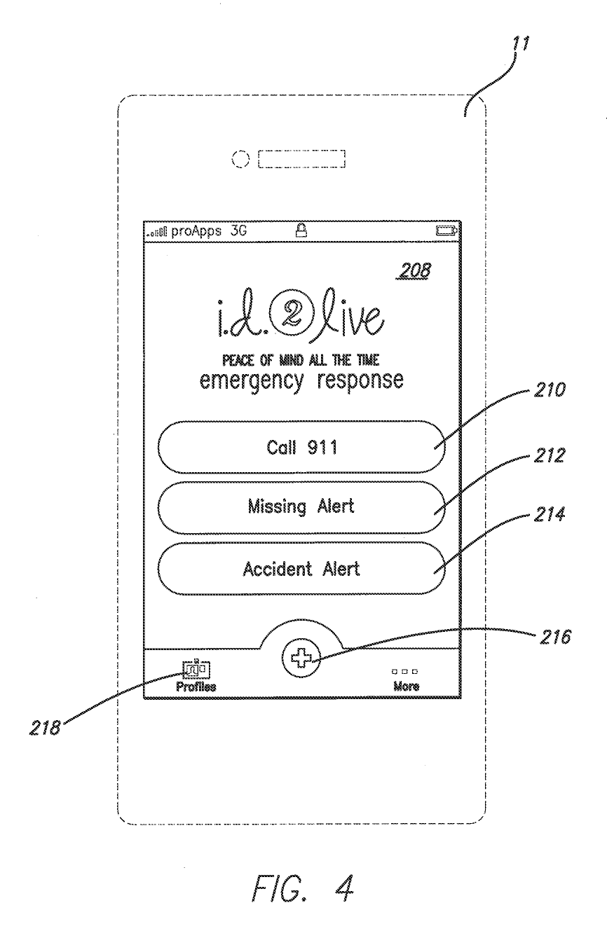

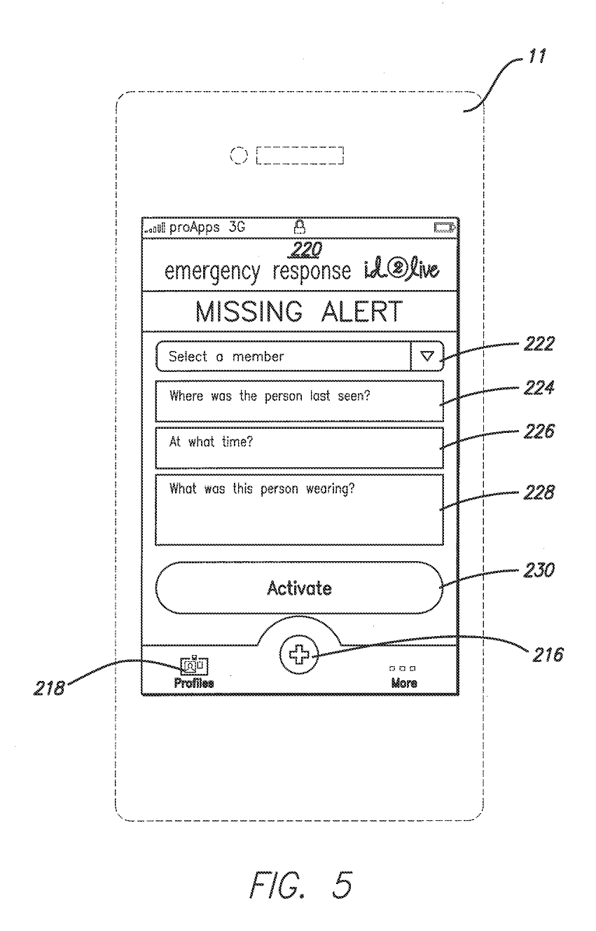

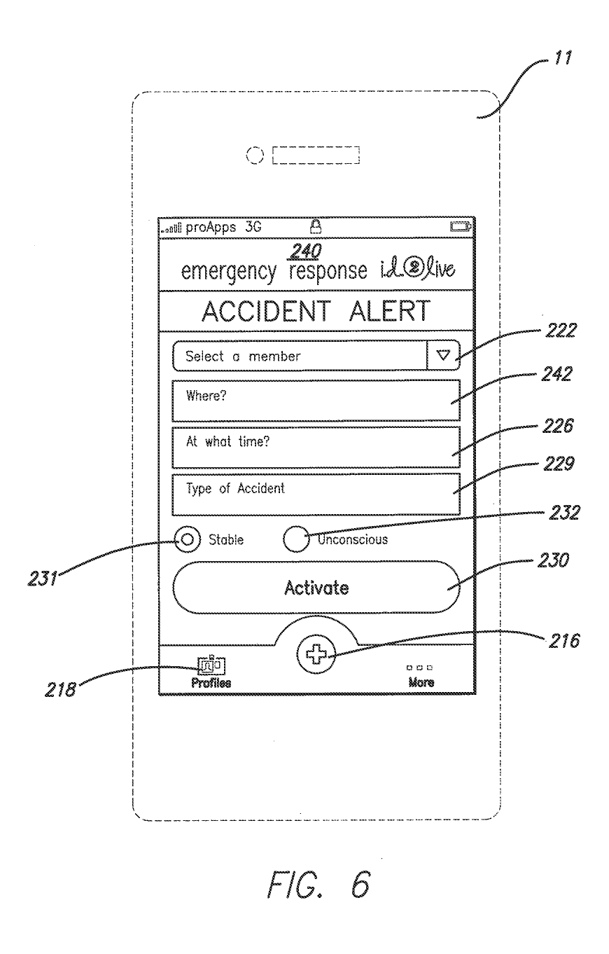

After the user logs in, the mobile computer device 11 displays a landing page in the form of an Emergency page 208, as shown in FIG. 4. From this page, the user can choose from the following options:
Call 911: The first thing to do in case of an emergency is call 911. The user can click on a Call 911 button 210 and the call will be placed automatically for devices with calling capability.
Missing Alert: If a registered member a missing person, the user can use the system to alert his or her contacts by clicking on a Missing Alert button 212 and following the instructions (see FIG. 5).
Accident Alert: if a registered member has an accident, a user can use the system to alert their emergency contacts by clicking on the Accident Alert button 214 and following the instructions (see FIG. 6).
   As shown in FIGS. 4-15, a View Profile button 218 and a Panic Button or Emergency Response button 216 (e.g., a red button with white cross) re displayed on the mobile device 11. Clicking the Emergency Response button 216 will display an Emergency Response page 208 as described in more detail below.

Still referring to FIG. 4, if the user selects the Missing Alert button 212, the system will respond by causing the mobile computer device to display a Missing Alert page 220. FIG. 5 shows an exemplary Missing Alert page 220, which prompts the user to provide the following information:
a Select a Member pulldown menu 222 prompts the user to select identify which registered member is missing;
a Where Was the Person Last Seen field 224 prompts the user to enter information regarding where the missing person was last seen;
an At What Time filed 226 prompts the user to enter information regarding when the missing person was last seen;
a What Was the Person Wearing field 228 prompts the user to enter information regarding what the missing person was wearing when they were last seen.

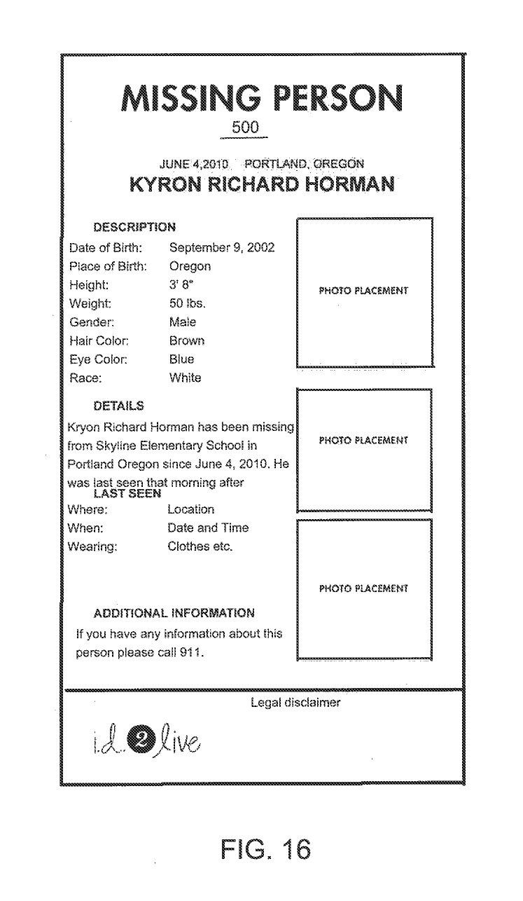

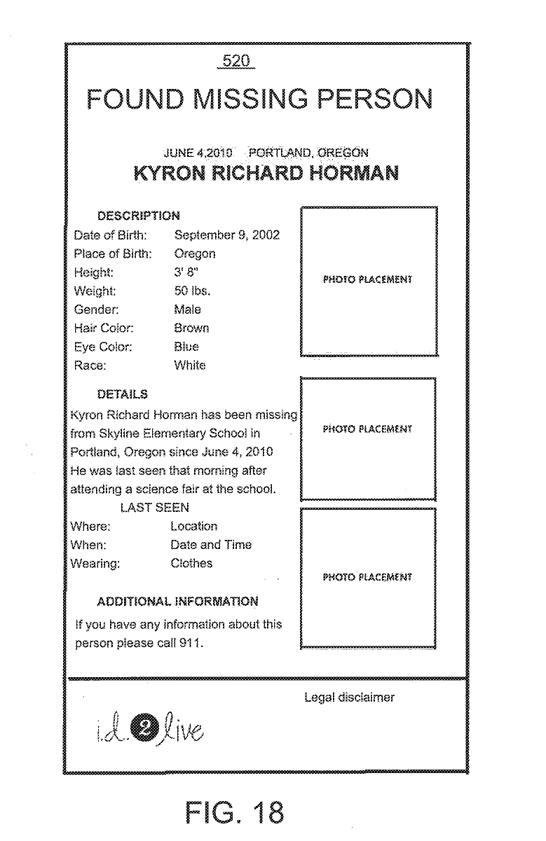

After entering this information, the user can activate a Missing Alert 500 by selecting an Activate button 30, and an e-flyer will be sent automatically by e-mail and/or SMS to all the contacts in the member's profile (the contacts are previously entered into the profile, and there is a feature to import contacts from the most common e-mail services). In addition, if the member has the Notify the ID2LIVE Army feature activated (in his/her profile), the missing alert will be also sent to this “army”, which is a group of people (also registered members) who are willing to help others spread the word of a Missing Alert and who have subscribed with the ID2Live system. One example of a Missing Alert 500 can be seen in FIG. 16. When a missing person is found, a corresponding notice of found person 520 also can be sent. An example of such a notice can be seen in FIG. 18.

Referring again to FIG. 4, if the user selects the Accident Alert button 214, the system will respond by causing the mobile computer device to display an Accident Alert page 240. FIG. 6 shows an exemplary Accident Alert page 240 displayed on the screen of the mobile computer device, which prompts the user to provide the following information:
the Select a Member pulldown menu 222 prompts the user to select identify which registered member had an accident;
a Where field 242 prompts the user to enter information regarding where the accident occurred;
the At What Time filed 226 prompts the user to enter information regarding when the accident occurred;
a Type of Accident field 229 prompts the user to enter information regarding the type of accident;
a Stable button 231 and an Unconscious button 232 prompt the user to enter information as to the accident victim's condition.
   After providing this information, the user can activate an Accident Alert 510 by selecting an Activate button 30, and an e-flyer will be sent automatically and immediately by e-mail and/or SMS to all the emergency contacts in the member's profile (the contacts are previously entered into the profile and designated as Emergency Contacts, and preferably there is a feature to import contacts from the most common e-mail services). An example of an Accident Alert 510 can be seen in FIG. 18.

### Member Profiles

As described above, a master account is created by a member while completing his or her first product order, which account information includes a Username (the username is the e-mail address) and a Password. The Master Account can hold as many Members/Profiles as needed, with just one Profile per member. The Master Account holder can view all the Members Profiles, edit them, etc. According to one aspect of the invention, the profile does not require certain potentially sensitive information, such as SSN, address, insurance number.

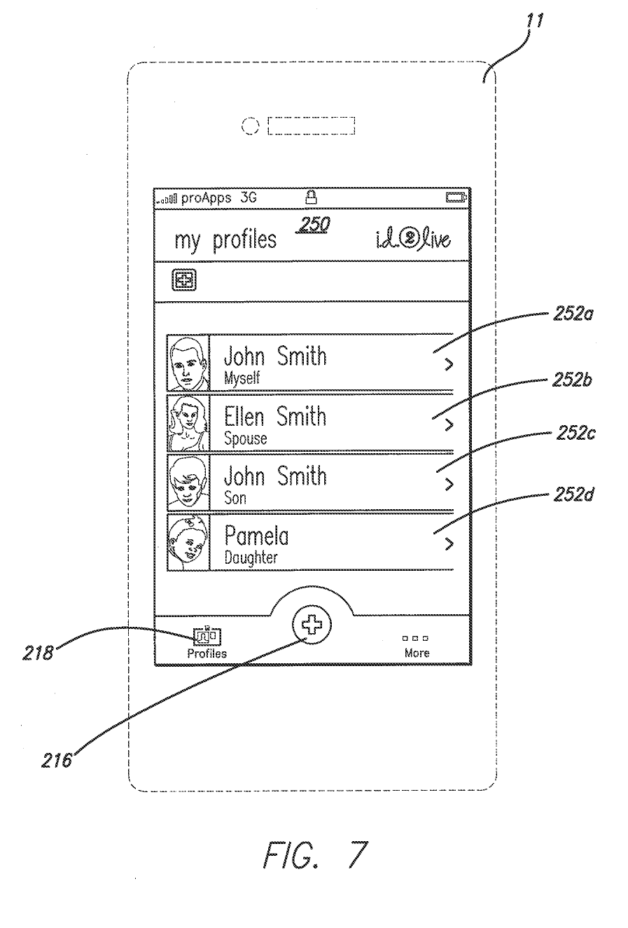

FIG. 7 shows an exemplary My Profiles page 250 displayed on the screen of the mobile computer device 11 for displaying and editing a member's profile information. The My Profiles page 250 includes Profile Selection buttons 252 for selecting one of the profiles associated with the master account. When the user selects one of the Profile Selection buttons 252, the system will respond by causing the mobile computer device to display an Identification Tools page 260.

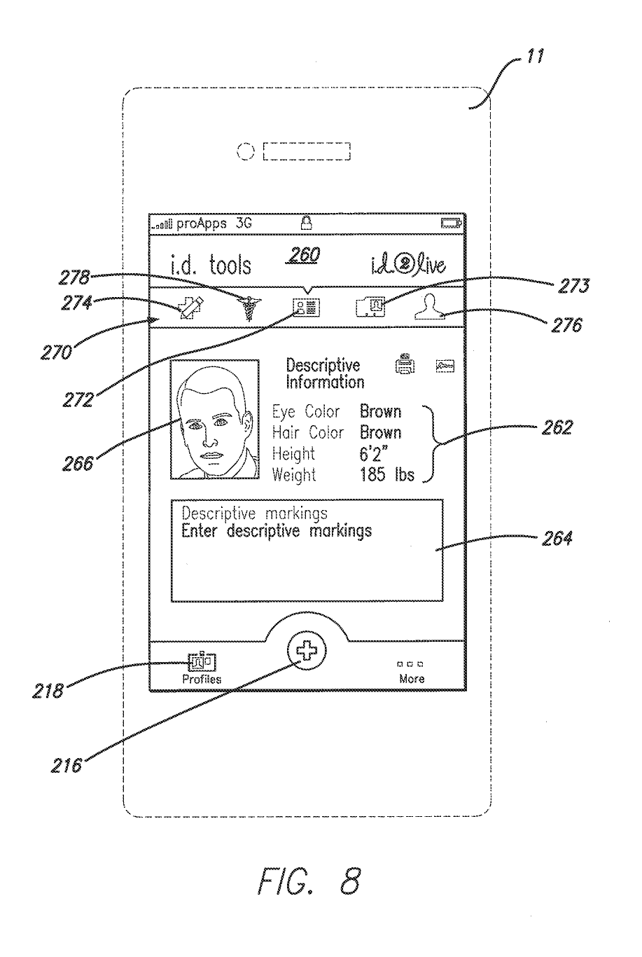

FIG. 8 shows an exemplary identification Tools page 260 displayed on the screen of the mobile computer device 11, which displays descriptive information 262 that is stored for the selected member profile. This information can include, for example:
Eye color
Hair color
Height
Weight
Descriptive markings
   A Descriptive Markings field 264 allows a user to enter and display descriptive markings for the selected profile, and an image display 266 allows the user to enter an image for the selected profile.

Referring to FIGS. 8-14, a number of the pages displayed by the mobile secure identification application 40 includes a navigation menu 270, which has icons for accessing certain features of the mobile secure identification application 40. For example, as shown in the navigation menu 270 seen in FIG. 8, these icons can include an Identification Tools icon 272, an Emergency Contacts icon 273, a Medical Information icon 274, a Name and Vital Information icon 275, a My Account icon 276, a Notes icon, and a Physicians icon 278. By selecting one of these icons, the user can access an associated page for displaying and entering information.

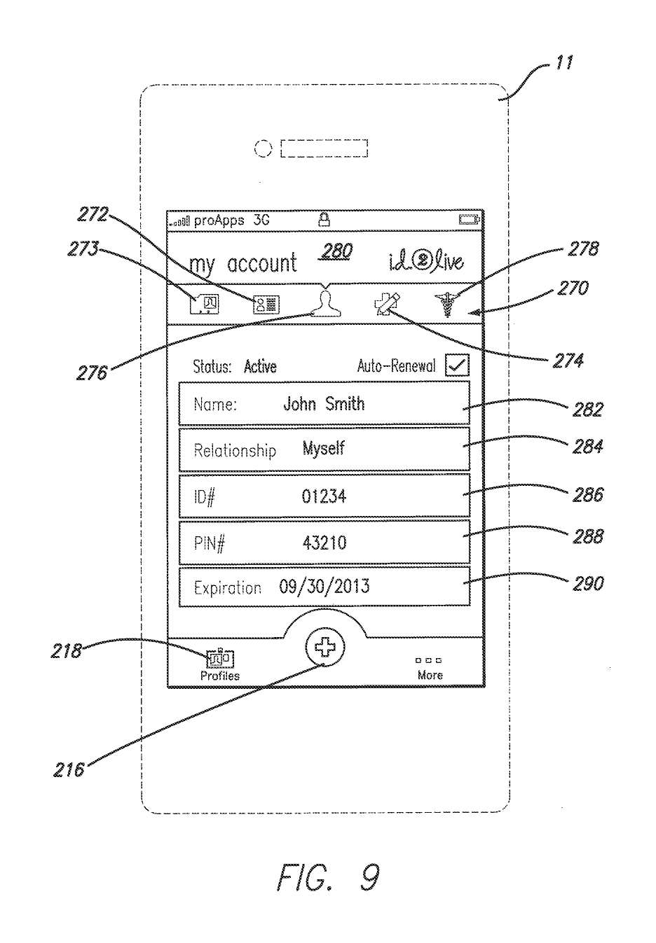

For example, by selecting the My Account icon 276, the user can access a My Account page 280. FIG. 9 shows an exemplary My Account page 280 displayed on the screen of the mobile computer device 11. This page displays fields for viewing and editing the Master Account information for the selected profile, including: a Name field 282, a Relationship field 284 showing the profiled member's relationship with the master account holder, an ID# field 286, a PIN# field 288, and an Expiration field 290 showing the membership expiration date for the profiled member.

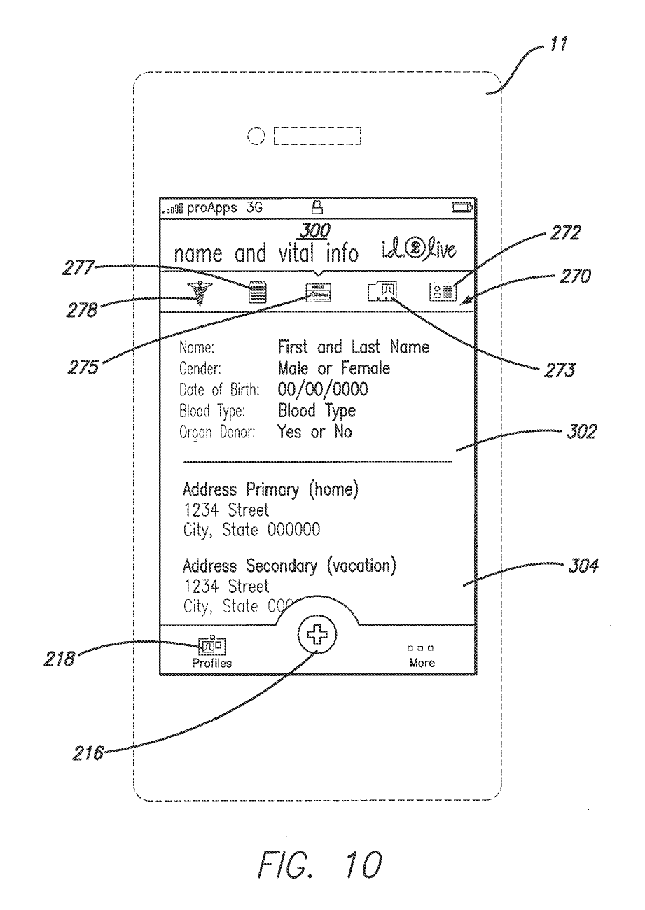

Referring to FIG. 10, by selecting the Name and Vital Information icon 275, the user can access a Name and Vital Information page 300. FIG. 10 shows an exemplary Name and Vital Information page 300 displayed on the screen of the mobile computer device 11. This page displays fields for viewing and editing the profiled member's name and vital information 302, including Name, Gender, Date of Birth, Blood Type and if the Member is an organ donor. In addition, the page 300 includes fields for displaying address information 304, which preferably just includes City, State and Zip Code.

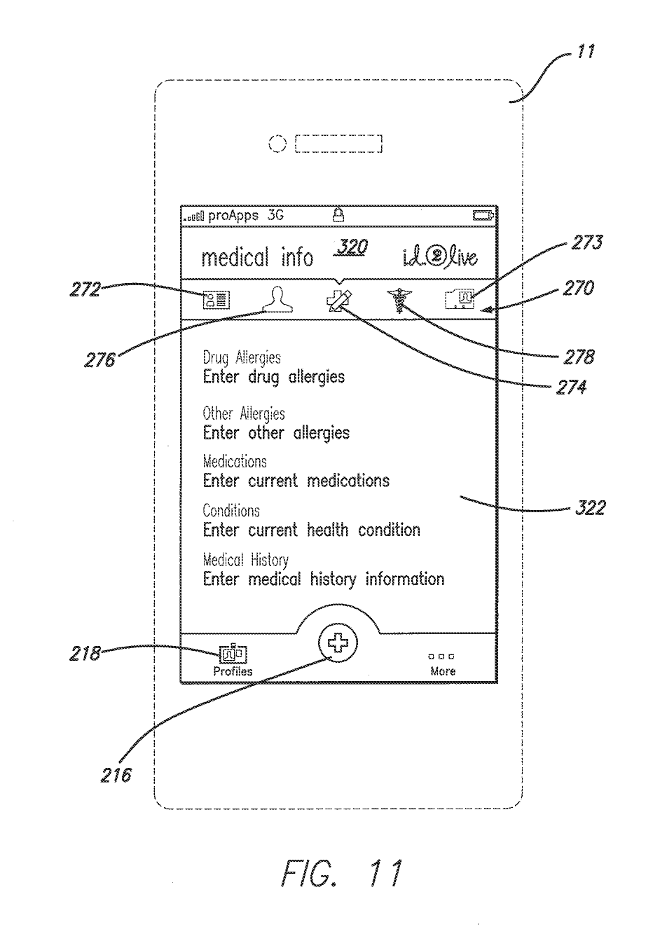

Referring to FIG. 11, by selecting the Medical Information icon 274, the user can access a Medical Information page 320. FIG. 11 shows an exemplary Medical Information page 320, which has a medical information section 322 for viewing and editing information for the selected profile, including the profiled member's Drug Allergies, Other Allergies, Medical Conditions, Medications being taken and the Medical History. The member can have as much information as he/she wants.

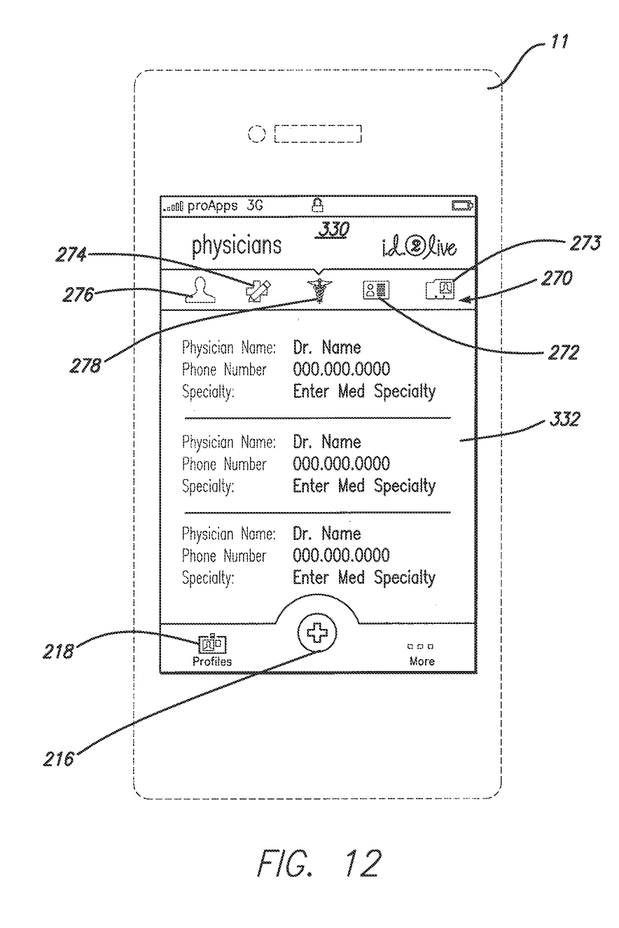

Referring to FIG. 12, by selecting the Physicians icon 278, the user can access a Physicians page 330. FIG. 12 shows an exemplary Physicians page 330, which has a physician information section 332 for viewing and editing such information about the physicians who are treating the profiled member, if any.

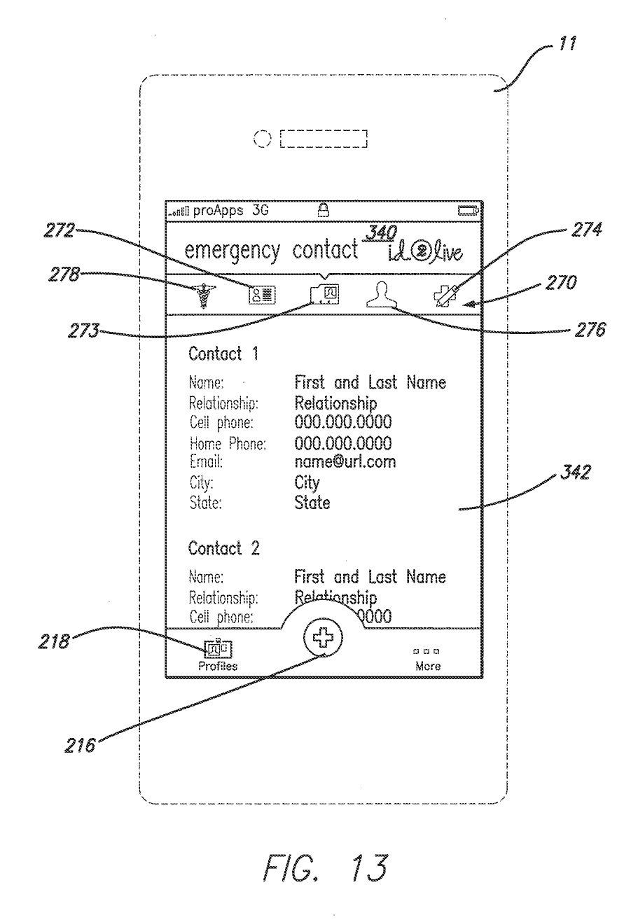

Referring to FIG. 13, by selecting the Emergency Contact icon 273, the user can access an Emergency Contact page 340. FIG. 13 shows an exemplary Emergency Contact page 340, which has a contact information section 342 for viewing and editing information regarding the profiled members emergency contacts who will get alerts in case of an Emergency Alert activation for the member.

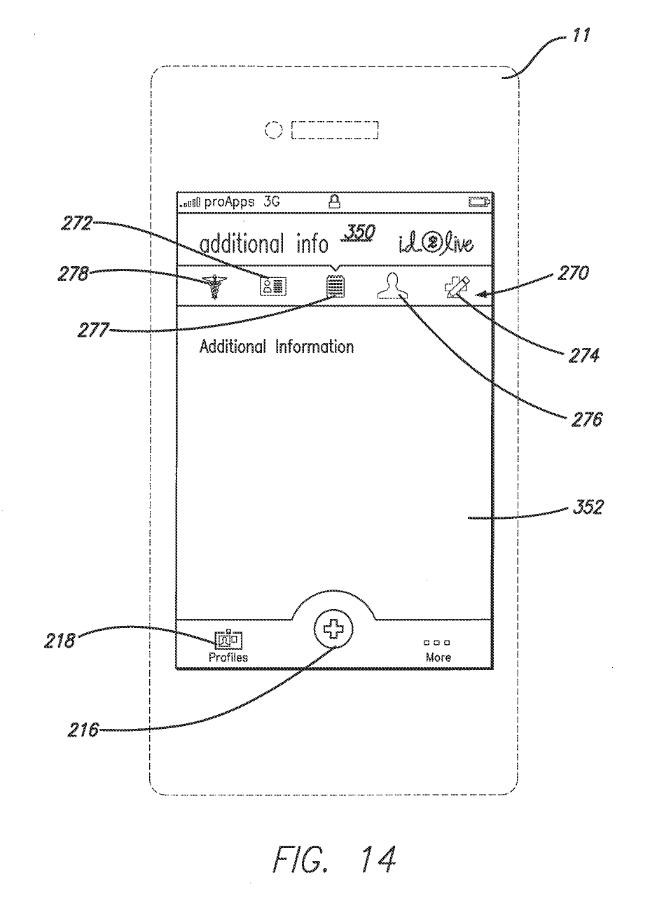

Referring to FIG. 14, by selecting the Notes icon 277, the user can access an Additional Information page 350. FIG. 14 shows an exemplary Additional Information page 350, which includes a text field 352 for adding and viewing any additional information about the profiled member.

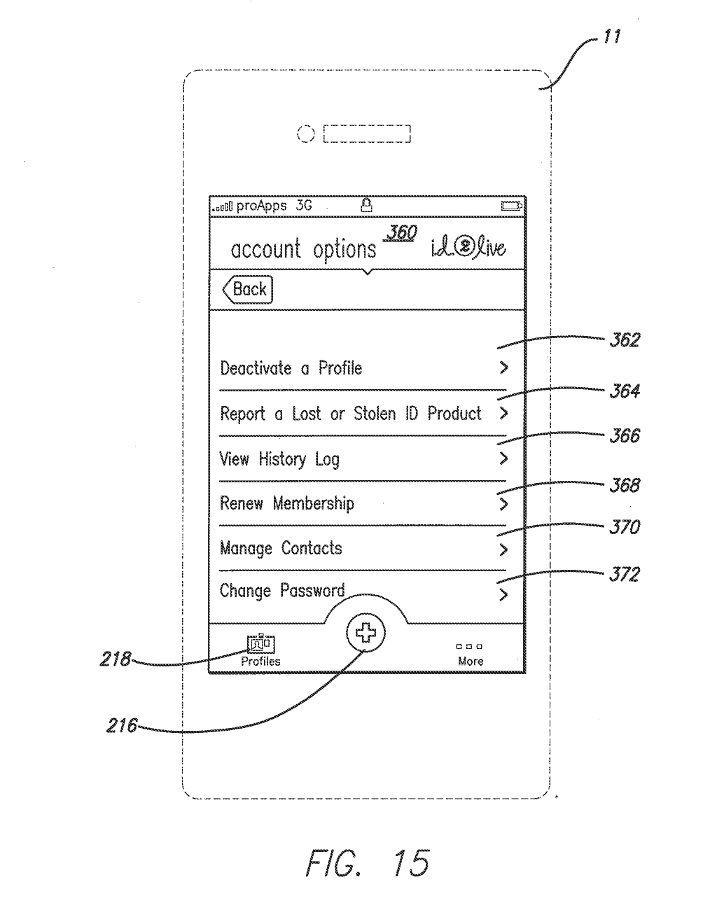

FIG. 15 shows an exemplary Account Options page 360 displayed on the screen of the mobile computer device 211, which includes the following links for the user to access the following features:
Deactivate a Profile 362;
Report a lost or stolen ID Product 364;
View History Log 366;
Renew Membership 368;
Manage Contacts 370:
Change Password 372.

Upon reading this disclosure, those skilled in the art will appreciate that various changes and modifications may be made to the preferred embodiments of the invention and that such changes and modifications may be made without departing from the spirit of the invention. Therefore, the invention in its broader aspects is not limited to the specific details, representative devices, and illustrative examples shown and described. Accordingly, departures may be made from such details without departing from the spirit or scope of the general inventive concept.

### APPENDIX A

### ID2Live Websites Documentation

the id2live.com

Technical Specifications:
WordPress 3.X
WP-Ecommerce plug-in 3.8.7.4
PHP 5.X
MySQL

The Id2Live web application consists of two sites. The front-end shopping site is the “ID2LIVE” site. This is the part of the application where a customer browses the products available online, selects the products he or she would like to purchase and places an order using a credit card.

The order processing and customer information is taken care of by the “MYID2LIVE” site. This is where the customer's contact information is maintained and accessed in case of an emergency. It is also where the products orders are processed. Separation of these sites ensures security of member data as that data is not accessible from the front end ecommerce site that is marketed to the public.

Product Navigation and Selection

Logins
1) Front-End ecommerce site. (for ordering).
2) Back-End user login
3) Back-End admin login
4) Emergency Responder

Responder

A customer may navigate the site using various menus and categories selections to find a product he/she is interested in. When a customer is viewing a product, the website also suggests other items to the customer in the ‘Related Items’ section.

Most items may be personalized to the customer's specifications. If an item can be personalized it can be either engraved with an image or personalized with text.

Image Engraving

If the customer would like to personalize an item with an image, the customer is prompted to upload an image file. Upon successfully uploading an image file, the customer may crop the area of the image to use for the engraving.

Text Personalization

Text personalization may be in stamped or laser engraved. Each individual ‘text personalized’ product has a set number of lines of text it can hold. Each line also has a limited number of characters. The customer may enter any text they would like to have on each line, as long as it is within the defined limits. The customer may also select the type of font they would like to be applied to the text.

Before adding an item to the shopping cart, the customer may preview the text on the website by clicking the Preview Font' button. This will display the personalized text line by line over a sample image. This allows the customer to view the layout of the text and review the text for any error or omissions.

Once the customer is satisfied with the text, he or she may select a product size to apply to the product and add the item to the cart.

Checkout

Once the customer is ready to checkout, they may click the ‘Checkout’ button or link available.

Upon checkout, the user can update or remove any item from the shopping cart. The can also review the personalization, if any, that has been applied to a product.

The customer is asked for standard credit card information including billing name and address. The customer is also asked to supply ‘Emergency Contact’ information to apply to the products being ordered. The customer may supply up to three Emergency Contacts, Each contact needs a name, phone, and email.

To complete the order, the customer is prompted to sign in, if they already have a sign in, or to register a new account. Once the customer has signed in they may complete their purchase using a credit card.

After successfully completing the order, the customer is displayed an online receipt and sent an email confirming the online order.

myid2live.com

Technical Specifications:
ASP
SQL Server

The ‘MYID2LIVE’ site is the area of the application where a customer may login to maintain their account details that are tied to a product.

Each purchased item has an ID and PIN number tied to it. It may also be supplied with other information, including the following:
Name and Vital Information
Name
Gender
Date of Birth
Home Phone
Cell Phone
Email
Primary Address
Secondary Address
Physicians
Drug Allergies
Other
Blood Type
Medications
Conditions
Medical History
Medical Information
Physician Name
Physician Number
Physician Specialty
2nd Physician Name
2nd Physician Number
2nd Physician Specialty
3rd Physician Name
3rd Physician Number
3rd Physician Specialty

Identification Tools

The customer may upload several images or videos that can be used to identify the person tied to the product. The customer may upload several images of the person. This can be done by standard means up web uploading (selecting an image file on a computer) or by using the ‘Pickup’ app available on an iphone, iPad iTouch. Along with an image the customer can provide the following information:
Eye color
Hair color
Height
Weight
Descriptive markings
The customer may also upload a fingerprint file and a video clip if available.
Additional information may also be supplied in free form text.
The emergency contact information that was initially identified on the order may also be viewed and maintained on the website.

Panic Button

Splits into two options:
1) Accident
2) Missing

This allows for information to be provided about those two possible cases. When activated the users contacts are notified. If accident the users emergency contacts, if missing then all the users contacts are notified.

ID2Live Army

As a compliment for the PANIC BUTTON, ID2Live offers the option of also sending the Missing Alerts to our ID2Live Army. The ID2Live Army is a group of people that is willing to help others in case of a Missing Person. Any member can OPT-IN and OPT-OUT of receiving such communications at any time. You can also decide if you want to include the ID2Live Army or not on your Missing Alerts and change this at any time. The ID2Live Army will receive the communications depending on the City and Zip Code of the Missing Person and the ID2Live Army member.

What is claimed is:

1. A method for storing and communicating a personal notification in the event of an emergency, the method comprising:
providing to an individual a personal identification item to be kept on the individual's person, wherein the personal identification item includes information for sending an emergency alert to a host computer system via a user computer device;
prompting the individual to provide personal information for storage by the host computer system, wherein the personal information includes medical information associated with the individual and emergency contact information for one or more contact persons;
using the host computer system to receive an emergency alert from the user computer device; and
in response to the emergency alert, using the emergency contact information to automatically communicate information relating to the emergency alert to the one or more contact persons.

2. The method of claim 1 wherein the user computer device comprises a mobile device.

3. The method of claim 1 wheren the user computer device comprises a smart phone.

4. The method of claim 1 wherein the personal identification item comprises jewelry that includes identification information for the individual.

5. The method of claim 1 wherein the personal identification item comprises an identification card for the individual.

6. The method of claim 1 wherein the medical information includes allergy information.

7. The method of claim 1 wherein the step of prompting the individual to provide personal information includes prompting the individual to provide physician information.

8. The method of claim 1 wherein the step of using the emergency contact information to automatically communicate information relating to the emergency alert to the one or more contact persons comprises sending an email to the one or more contact persons.

9. The method of claim 1 wherein the step of using the emergency contact information to automatically communicate information relating to the emergency alert to the one or more contact persons comprises sending a text message to the one or more contact persons.

10. The method of claim 1 wherein the emergency alert comprises a missing person alert.

11. The method of claim 1 wherein the emergency alert comprises an accident alert.

12. A computer network system for storing and communicating a personal notification in the event of an emergency, the system comprising:
a host computer system including a computer processor and a database operative with computer processor to store personal information associated with an individual, including medical information and emergency contact information for one or more contact persons;
wherein the individual has a personal identification item that includes information for sending an emergency alert to the host computer system via a user computer device; and
wherein the computer processor is operative to:
prompt the individual to provide the personal information for storage by the host computer system;
receive an emergency alert from the user computer device; and
in response to the emergency alert, use the emergency contact information to automatically communicate information relating to the emergency alert to the one or more contact persons.

13. The system of claim 12 wherein the user computer device is a mobile device.

14. The system of claim 12 wherein the personal identification item comprises jewelry that includes identification information for the individual.

15. The system of claim 12 wherein the personal identification item comprises an identification card for the individual,

16. The system of claim 12 wherein the medical information includes allergy information.

17. The system of claim 12 wherein the personal information includes physician information.

18. The system of claim 12 wherein the emergency alert comprises a missing person alert.

19. The system of claim 12 wherein the emergency alert comprises an accident alert,

20. A computer system for storing and communicating a personal notification in the event of an emergency, the system comprising:
a user computer device operative to communicate with a host computer system;
wherein the host computer system includes a computer processor and a database operative with computer processor to store personal information associated with an individual and including medical information and emergency contact information for one or more contact persons;
wherein the individual has a personal identification item that includes information for sending an emergency alert to the host computer system via the user computer device; and
wherein the computer processor is operative to:
prompt the individual via the user computer device to provide the personal information for storage by the host computer system;
receive an emergency alert from the user computer device; and
in response to the emergency alert, use the emergency contact information to automatically communicate information relating to the emergency alert to the one or more contact persons.
